(19) United States
(12) Patent Application Publication
(10) Pub. No.: US 2026/0141506 A1
(43) Pub. Date: May 21, 2026

(54) METHOD AND DEVICE CONFIGURED FOR QUALITY INSPECTIONS, AND METHOD CONFIGURED FOR TRAINING INSPECTION MODELS

(71) Applicant: Fulian Precision Electronics (Tianjin) Co., LTD., Tianjin (CN)

(72) Inventors: TSAI-PING CHU, New Taipei (TW); CHENG-JU YANG, Taipei (TW); WAN-HSIN TARING, New Taipei (TW)

(21) Appl. No.: 18/973,381

(22) Filed: Dec. 9, 2024

(30) Foreign Application Priority Data
Nov. 19, 2024 (CN) 202411657246.6

(51) Int. Cl. G06T 7/00; G06V 10/74; G06V 10/764; G06V 20/70

(52) U.S. Cl. CPC G06T 7/0008; G06V 10/761; G06V 10/764; G06V 20/70; G06T 2207/30141

(57) ABSTRACT

A method configured for quality inspections is provided. The method comprises: obtaining an image dataset of components on a circuit board to be tested, and the image dataset includes N class labeled datasets corresponding to N labels, N>1 and N is an integer; providing and training an inspection model to output inspection results; inputting the image dataset into the inspection model to obtain the inspection results; when the inspection results meet a preset inspection standard, outputting the inspection results; when the inspection results do not meet the preset inspection standard, selecting an abnormal reason according to the image dataset and a model attention area; and adjusting the image dataset or the model attention area according to the abnormal reason until the inspection results meet the preset inspection standard.

### CROSS-REFERENCE TO RELATED APPLICATIONS

This application claims priority to Chinese Patent Application No. 202411657246.6 filed on Nov. 19, 2024, in China National Intellectual Property Administration, the contents of which are incorporated by reference herein.

### FIELD

The subject matter herein generally relates to quality inspections technology field, and more particularly to a method and device configured for quality inspections, and a method configured for training inspection models.

### BACKGROUND

A device configured for quality inspections is used to inspect qualities of various components or products on a product line, and various dedicated inspection models are established through the device to deal with different types of inspection objects, such that accuracies of quality inspections are improved. However, with types of inspection objects are increased, a number of the dedicated inspection models is increased, such that requirements of the hardware configuration for the device are raised and detection costs are increased.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flowchart of a method configured for quality inspections provided by an embodiment of the present disclosure.

FIG. 2 is a diagram of a process for processing images provided by an embodiment of the present disclosure.

FIG. 3 is a diagram of a process for defining labels provided by an embodiment of the present disclosure.

FIG. 4 is a correspondence table between label numbers and label names provided by an embodiment of the present disclosure.

FIG. 5 is a diagram of a 17×17 confusion matrix provided by an embodiment of the present disclosure.

FIG. 6 is a diagram of a 2×2 confusion matrix converted from the 17×17 confusion matrix in FIG. 5.

FIG. 7 is a diagram of a 5×5 confusion matrix provided by an embodiment of the present disclosure.

FIG. 8 is a diagram of a 2×2 confusion matrix converted from the 5×5 confusion matrix in FIG. 7.

FIG. 9 is a flowchart of a method configured for training inspection models provided by an embodiment of the present disclosure.

FIG. 10 is an appearance diagram of a device configured for automated optical inspections by an embodiment of the present disclosure.

FIG. 11 is a software structure diagram of a device configured for quality inspections provided by an embodiment of the present disclosure.

FIG. 12 is a hardware structure diagram of a device configured for quality inspections provided by an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “comprising,” when utilized, means “including, but not necessarily limited to”; it specifically indicates open-ended inclusion or membership in the so-described combination, group, series, and the like.

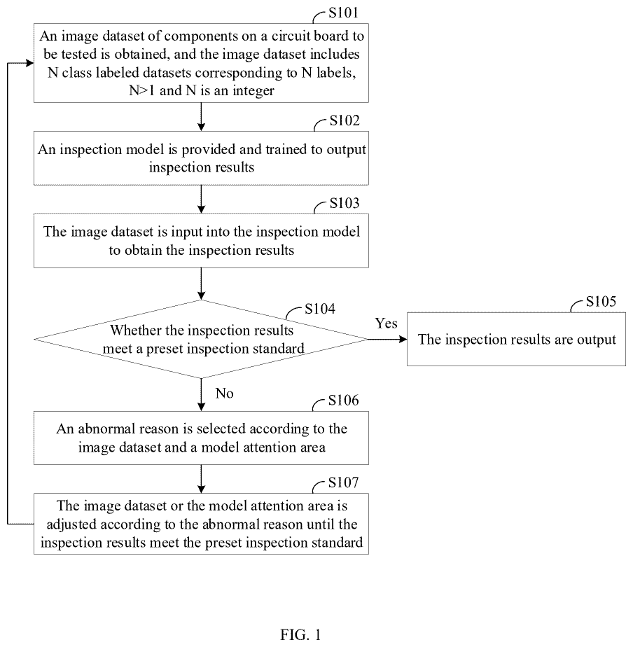

FIG. 1 is a flowchart of a method configured for quality inspections. As shown in FIG. 1, the method includes the following blocks.

At block S101, an image dataset of components on a circuit board to be tested is obtained, and the image dataset includes N class labeled datasets corresponding to N labels, N>1 and N is an integer.

In block S101, at least one component may be installed on the circuit board. The at least one component may include, but is not limited to, resistors, capacitors, and diodes. The circuit board may be a printed circuit board (PCB) or a flexible printed circuit (FPC).

In this embodiment, obtaining the image dataset of components on a circuit board to be tested comprises: capturing original images of the components on the circuit board through invoking a camera; cropping the original images according to several inspection boxes to obtain several cropped images; performing size transformation on the several cropped images to obtain several images to be labeled, and the several images to be labeled are the same size; and labeling the several images to be labeled according to N labels to obtain N class labeled datasets corresponding to the N labels.

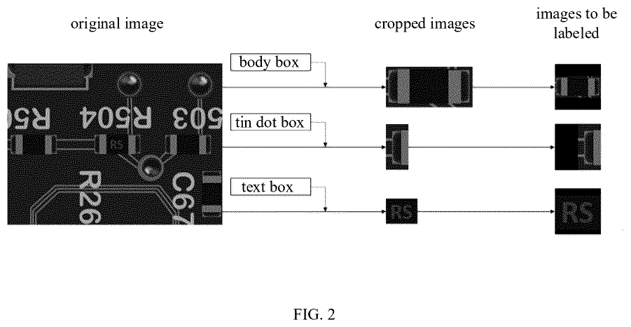

In this embodiment, an inspection box is used to crop images of a target area from original images according to target coordinate information. The target coordinate information includes coordinates of several feature points located on a boundary of the target area in an image coordinate system. For example, as shown in FIG. 2, several inspection boxes include a body box, a tin dot box, and a text box. The body box is used to crop images of bodies of components from original images according to coordinate information of the body box. The tin dot box is used to crop images of tin dots of the components from the original images according to coordinate information of the tin dot box. The text box is used to crop images of labeled text near bodies of the components from the original images according to coordinate information of the text box.

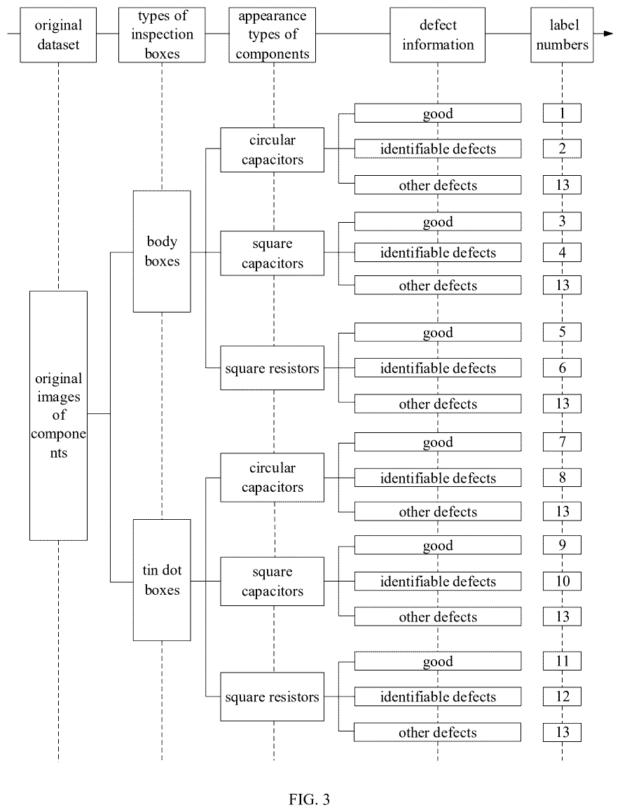

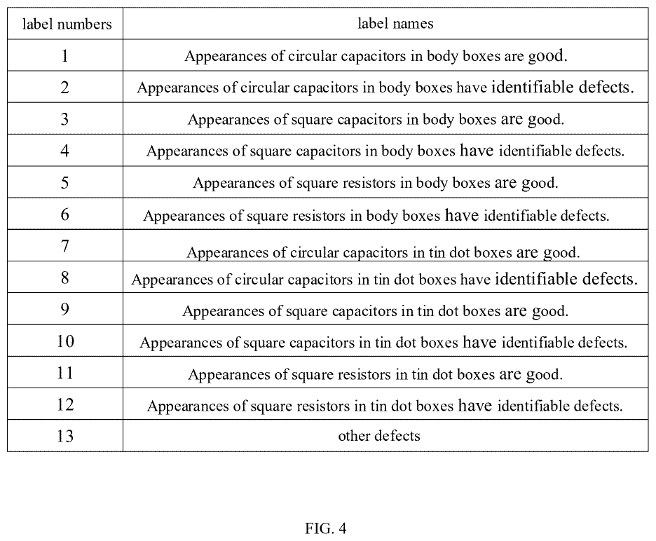

In this embodiment, the N labels may be defined according to types of inspection boxes, appearance types of components, and whether there are defects on appearances of the components. For example, as shown in FIG. 3, a circuit board to be tested includes resistors and capacitors. An original dataset includes original images of the resistors and original images of the capacitors. Types of inspection boxes include body boxes and tin dot boxes. Appearances types of components include circular capacitors, square capacitors, and square resistors. 13 labels are defined according to the types of inspection boxes, the appearances types of components, and whether there are defects on appearances of the components, and label numbers are used to distinguish the 13 labels. As shown in FIG. 4, each label number corresponds to a label name. Each label name comprises defect information about appearance of a component, and the defect information includes “good”, “identifiable defects”, and “other defects”. The “good” indicates no defect on appearances of components. The “identifiable defects” indicates identifiable defects on appearances of components. The identifiable defects may include dirt on appearances of components, displacement of components, and a large amount of tin on solder points of components. The “other defects” indicate unidentifiable defects on appearances of components. The unidentifiable defects may include components overturning and components missing.

At block S102, an inspection model is provided and trained to output inspection results.

In this embodiment, training the inspection model comprises: calculating a missed inspection rate by calculating a percentage of a number of first abnormal images to a number of images in the image dataset that do not meet a preset images standard, and the first abnormal images are images in the image dataset that have defects but are classified as images meeting the preset images standard; calculating an overkill rate by calculating a percentage of a number of second abnormal images to a number of images in the image dataset that meet the preset images standard, and the second abnormal images are images in the image dataset that meet the preset images standard but are classified as images having defects; and including the missed inspection rate and/or the overkill rate in the inspection results.

In other embodiments, training the inspection model further comprises: calculating an overkill reduction rate and a sum of the overkill reduction rate and the overkill rate is 100 %; and including the overkill reduction rate in the inspection results.

At block S103, the image dataset is input into the inspection model to obtain the inspection results.

In this embodiment, classes of the inspection model is not limited, for example, the inspection model may be a YOLOv7 model or an EfficientDet model.

In this embodiment, a confusion matrix may be constructed through the inspection model according to the image dataset, and the missed inspection rate and the overkill rate are calculated according to the confusion matrix.

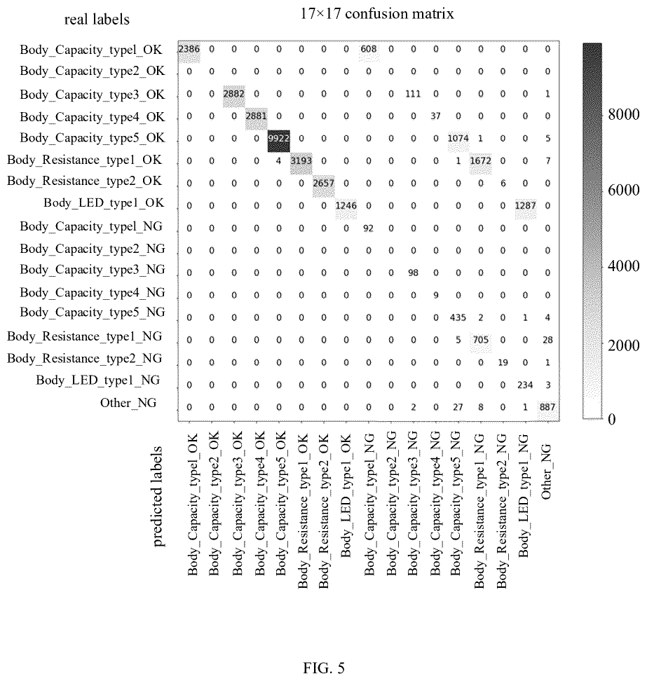

For example, the image dataset includes 17 labeled datasets corresponding to 17 labels. A 17×17 confusion matrix is constructed through the inspection model according to the image dataset. As shown in FIG. 5, in the 17×17 confusion matrix, a row indicates a number of images in a labeled dataset corresponding to a real label, and a column indicates a number of images in a labeled dataset corresponding to a predicted label. A number of images in labeled datasets corresponding to real labels are pre-stored, and a number of images in the labeled datasets corresponding to predicted labels are predicted through the inspection model according to the image dataset.

As shown in FIG. 5, the row “Body_Capacity_type1_OK” indicates a number of images in a labeled dataset corresponding to the real label “Body_Capacity_type1_OK”. The row “Body_Capacity_type1_OK” comprises a number of images in a labeled dataset corresponding to the predicted label “Body_Capacity_type1_OK” which is 2386, and a number of images in a labeled dataset corresponding to the predicted label “Body_Capacity_type1_NG” which is 608. It can be inferred from the row “Body_Capacity_type1_OK” that a number of images in a labeled dataset corresponding to the real label “Body_Capacity_type1_OK” that meet the preset images standard but are classified as images having defects is 608, such that a number of the second abnormal images corresponding to the label “Body_Capacity_type1_OK” is 608.

As shown in FIG. 5, the row “Body_Capacity_type1_NG” indicates a number of images in a labeled dataset corresponding to the real label “Body_Capacity_type1_NG”. The row “Body_Capacity_type1_NG” comprises a number of images in a labeled dataset corresponding to the predicted label “Body_Capacity_type1_OK” which is 0, and a number of images in a labeled dataset corresponding to the predicted label “Body_Capacity_type1_NG” which is 92. It can be inferred from the row “Body_Capacity_type1_NG” that a number of images in a labeled dataset corresponding to the real label “Body_Capacity_type1_NG” that have defects but are classified as images meeting the preset images standard is 0, such that a number of the first abnormal images corresponding to the label “Body_Capacity_type1_NG” is 0.

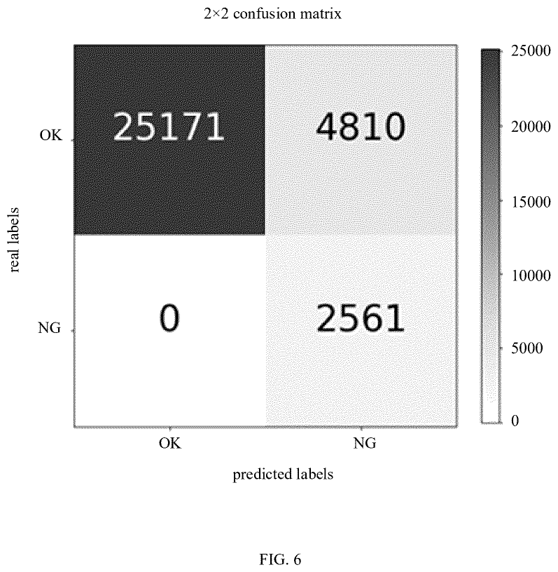

Furthermore, the 17×17 confusion matrix is converted into a 2×2 confusion matrix through the inspection model. As shown in FIG. 6, in the 2×2 confusion matrix, the row “OK” indicates a total number of images in labeled datasets corresponding to real labels with label names comprising “OK”. The row “OK” comprises a total number of images in labeled datasets corresponding to predicted labels with label names comprising “OK” which is 25171, and a total number of images in labeled datasets corresponding to predicted labels with label names comprising “NG” which is 4810. It can be inferred from the row “OK” that a total number of images in labeled datasets corresponding to real labels with label names comprising “OK” that meet the preset images standard but are classified as images having defects is 4810, such that a total number of the second abnormal images is 4810.

As shown in FIG. 6, the row “NG” indicates a total number of images in labeled datasets corresponding to real labels with label names comprising “NG”. The row “NG” comprises a total number of images in labeled datasets corresponding to predicted labels with label names comprising “OK” which is 0, and a total number of images in labeled datasets corresponding to predicted labels with label names comprising “NG” which is 2561. It can be inferred from the row “NG” that a total number of images in labeled datasets corresponding to real labels with label names comprising “NG” that have defects but are classified as images meeting the preset images standard is 0, such that a total number of the first abnormal images is 0.

The missed inspection rate and the overkill rate are calculated through the inspection model according to the 2×2 confusion matrix. The missed inspection rate is 0/2561=0 %, and the overkill rate is 4810/(25171+4810)=16 %.

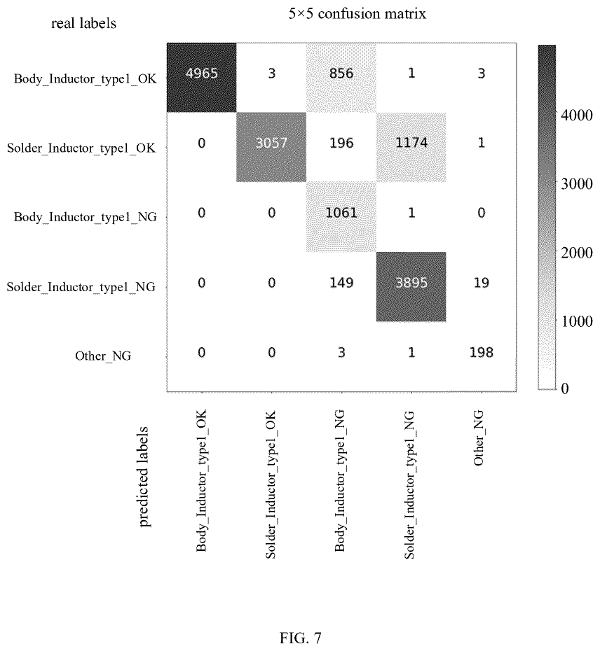

In another example, the image dataset includes 5 labeled datasets corresponding to 5 labels. A 5×5 confusion matrix is constructed through the inspection model according to the image dataset. As shown in FIG. 7, in the 5×5 confusion matrix, a row indicates a number of images in a labeled dataset corresponding to a real label, and a column indicates a number of images in a labeled dataset corresponding to a predicted label. A number of images in labeled datasets corresponding to real labels are pre-stored, and a number of images in the labeled datasets corresponding to predicted labels are predicted through the inspection model according to the image dataset.

As shown in FIG. 7, the row “Body_Inductor_type1_OK” indicates a number of images in a labeled dataset corresponding to the real label “Body_Inductor_type1_OK”. The row “Body_Inductor_type1_OK” comprises a number of images in a labeled dataset corresponding to the predicted label “Body_Inductor_type1_OK” which is 4965, a number of images in a labeled dataset corresponding to the predicted label “Solder_Inductor_type1_OK” which is 3, a number of images in a labeled dataset corresponding to the predicted label “Body_Inductor_type1_NG” which is 856, a number of images in a labeled dataset corresponding to the predicted label “Solder_Inductor_type1_NG” which is 1, and a number of images in a labeled dataset corresponding to the predicted label “Other_NG” which is 3. It can be inferred from the row “Body_Inductor_type1_OK” that a number of images in a labeled dataset corresponding to the real label “Body_Inductor_type1_OK” that meet the preset images standard but are classified as images having defects is 856, such that a number of the second abnormal images corresponding to the label “Body_Inductor_type1_OK” is 856.

As shown in FIG. 7, the row “Body_Inductor_type1_NG” indicates a number of images in a labeled dataset corresponding to the real label “Body_Inductor_type1_NG”. The row “Body_Inductor_type1_NG” comprises a number of images in a labeled dataset corresponding to the predicted label “Body_Inductor_type1_OK” which is 0, a number of images in a labeled dataset corresponding to the predicted label “Body_Inductor_type1_NG” which is 1061, and a number of images in a labeled dataset corresponding to the predicted label “Solder_Inductor_type1_NG” which is 1. It can be inferred from the row “Body_Inductor_type1_NG” that a number of images in a labeled dataset corresponding to the real label “Body_Inductor_type1_NG” that have defects but are classified as images meeting the preset images standard is 0, such that a number of the first abnormal images corresponding to the label “Body_Inductor_type1_NG” is 0.

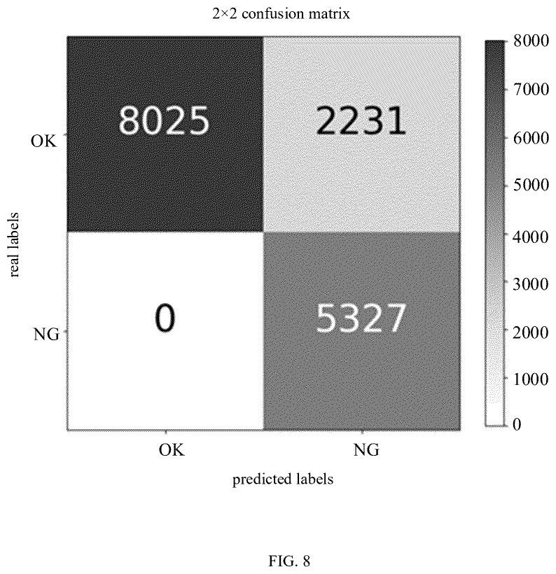

Furthermore, the 5×5 confusion matrix is converted into a 2×2 confusion matrix through the inspection model. As shown in FIG. 8, in the 2×2 confusion matrix, the row “OK” indicates a total number of images in labeled datasets corresponding to real labels with label names comprising “OK”. The row “OK” comprises a total number of images in labeled datasets corresponding to predicted labels with label names comprising “OK” which is 8025, and a total number of images in labeled datasets corresponding to predicted labels with label names comprising “NG” which is 2231. It can be inferred from the row “OK” that a total number of images in labeled datasets corresponding to real labels with label names comprising “OK” that meet the preset images standard but are classified as images having defects is 2231, such that a total number of the second abnormal images is 2231.

As shown in FIG. 8, the row “NG” indicates a total number of images in labeled datasets corresponding to real labels with label names comprising “NG”. The row “NG” comprises a total number of images in labeled datasets corresponding to predicted labels with label names comprising “OK” which is 0, and a total number of images in labeled datasets corresponding to predicted labels with label names comprising “NG” which is 5327. It can be inferred from the row “NG” that a total number of images in labeled datasets corresponding to real labels with label names comprising “NG” that have defects but are classified as images meeting the preset images standard is 0, such that a total number of the first abnormal images is 0.

The missed inspection rate and the overkill rate are calculated through the inspection model according to the 2×2 confusion matrix. The missed inspection rate is 0/5327=0 %, and the overkill rate is 2231/(8025+2231)=22 %.

At block S104, whether the inspection results meet a preset inspection standard is determined.

In block S104, when the inspection results meet the preset inspection standard is determined, block S105 is implemented. When the inspection results do not meet the preset inspection standard is determined, blocks S106-S107 are implemented.

In this embodiment, the inspection results meet the preset inspection standard when: the inspection results include the missed inspection rate and the missed inspection rate is less than or equal to a missed inspection rate threshold; or the inspection results include the overkill rate and the overkill rate is less than or equal to an overkill rate threshold; or the inspection results include the missed inspection rate and the overkill rate, wherein the missed inspection rate is less than or equal to the missed inspection rate threshold, and the overkill rate is less than or equal to the overkill rate threshold. Wherein the missed inspection rate threshold and the overkill rate threshold may be set as desired.

In other embodiments, the inspection results meet the preset inspection standard when the inspection results include the overkill reduction rate and the overkill reduction rate is greater than an overkill reduction rate threshold. Wherein the overkill reduction rate threshold may be set as desired.

At block S105, the inspection results are output.

At block S106, an abnormal reason is selected according to the image dataset and a model attention area.

In this embodiment, selecting the abnormal reason comprises: traversing the N class labeled datasets, and calculating a feature similarity between an i-th class labeled dataset of the N class labeled datasets and a j-th class labeled dataset of the N class labeled datasets to obtain a total of K feature similarities corresponding to the N class labeled datasets; when the K feature similarities are less than a similarity threshold, and the model attention area is in a target range, selecting lacking model input data as the abnormal reason; when the K feature similarities are less than a similarity threshold, and the model attention area is out of the target range, selecting inaccurate model attention area as the abnormal reason; and when one of the K feature similarities is greater or equal to the similarity threshold, selecting inaccurate labels classification as the abnormal reason.

Wherein, K=N×(N- 1)/2, 1≤i≤N, 1≤j≤N, each i and j is an integer, and i≠j. The target range refers to an area covered by an entire component in an image. The target range and the similarity threshold may be set as desired.

In this embodiment, whether the model attention area is in the target range may be determined through a neural network visualization method, and the neural network visualization method comprises Gradient weighted Class Activation Mapping (Grad CAM) method.

In this embodiment, traversing the N class labeled datasets, and calculating a feature similarity between an i-th class labeled dataset of the N class labeled datasets and a j-th class labeled dataset of the N class labeled datasets, which is equivalent to calculating feature similarities between any two class labeled datasets in the N class labeled datasets. For example, N=5, calculating feature similarities between any two class labeled datasets in the 5 class labeled datasets to obtain a total of K feature similarities, K=5×4/2=10.

In this embodiment, a feature similarity is used to measure the similarity degree between two class labeled datasets. The feature similarity may include, but is not limited to, cosine similarity and Euclidean distance.

In other embodiments, before traversing the N class labeled datasets, and calculating a feature similarity between an i-th class labeled dataset of the N class labeled datasets and a j-th class labeled dataset of the N class labeled datasets, sampling the N class labeled datasets to reduce the latency of calculating feature similarities through a sampling method. The sampling method may include, but is not limited to, inverse transform sampling algorithm, accept reject sampling method, and Monte Carlo sampling method.

At block S107, the image dataset or the model attention area is adjusted according to the abnormal reason until the inspection results meet the preset inspection standard.

In this embodiment, when lacking model input data is selected as the abnormal reason, a number of images in the image dataset is increased, and blocks S101-S104 are implemented.

When inaccurate model attention area is selected as the abnormal reason, the model attention area is revised according to auxiliary learning images, and blocks S101-S104 are implemented. The auxiliary learning images are pre-stored, which comprise accurate model attention area.

Wherein, revising the model attention area comprises: adding patches to images in the image dataset based on the auxiliary learning images to guide the inspection model to focus on an area in the target range. Size and position of the patches are defined based on the model attention area in the auxiliary learning images.

When inaccurate labels classification is selected as the abnormal reason, the N labels are revised, and blocks S101-S104 are implemented.

The above description illustrates a method configured for quality inspections, which depends on the inspection model. Below is a detailed description of a method configured for training inspection models.

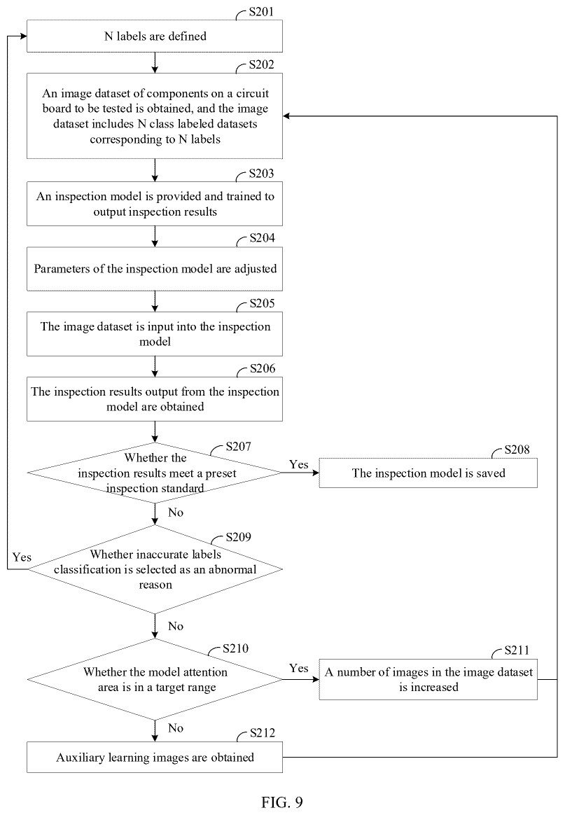

FIG. 9 is a flowchart of a method configured for training inspection models. As shown in FIG. 9, the method includes the following blocks.

At block S201, N labels are defined.

In this embodiment, the N labels may be defined according to types of inspection boxes, appearance types of components, and whether there are defects on appearances of components.

At block S202, an image dataset of components on a circuit board to be tested is obtained, and the image dataset includes N class labeled datasets corresponding to N labels.

At block S203, an inspection model is provided and trained to output inspection results.

At block S204, parameters of the inspection model are adjusted.

In this embodiment, the parameters comprise model structure and hyperparameters. For example, the model structure may be adjusted through changing a number of convolutional layers. In another example, the hyperparameters comprise activation functions, and different activation functions are used to different class circuit boards.

At block S205, the image dataset is input into the inspection model.

At block S206, the inspection results output from the inspection model are obtained.

In this embodiment, the inspection results includes a missed inspection rate and/or an overkill rate.

At block S207, whether the inspection results meet a preset inspection standard is determined.

In this embodiment, the inspection results meet a preset inspection standard when: the inspection results include the missed inspection rate and the missed inspection rate is less than or equal to a missed inspection rate threshold; or the inspection results include the overkill rate and the overkill rate is less than or equal to an overkill rate threshold; or the inspection results include the missed inspection rate and the overkill rate, wherein the missed inspection rate is less than or equal to the missed inspection rate threshold, and the overkill rate is less than or equal to the overkill rate threshold.

In block S207, when the inspection results meet the preset inspection standard, meaning that training the inspection model is finished, and block S208 is implemented. When the inspection results do not meet the preset inspection standard, meaning that training the inspection model is unfinished, and block S209 is implemented.

At block S208, the inspection model is saved.

At block S209, whether inaccurate labels classification is selected as an abnormal reason.

In block S209, when inaccurate labels classification is selected as the abnormal reason, blocks S201-S207 are implemented. When inaccurate labels classification is unselected as the abnormal reason, block S210 is implemented.

In this embodiment, the abnormal reason is selected according to the image dataset and a model attention area, and selecting the abnormal reason comprises: traversing the N class labeled datasets, and calculating a feature similarity between an i-th class labeled dataset of the N class labeled datasets and a j-th class labeled dataset of the N class labeled datasets to obtain a total of K feature similarities corresponding to the N class labeled datasets; when the K feature similarities are less than a similarity threshold, and the model attention area is in a target range, selecting lacking model input data as the abnormal reason; when the K feature similarities are less than a similarity threshold, and the model attention area is out of the target range, selecting inaccurate model attention area as the abnormal reason; and when one of the K feature similarities is greater or equal to the similarity threshold, selecting inaccurate labels classification as the abnormal reason.

Wherein, K=N×(N-1)/2, 1≤i≤N, 1≤j≤N, each i and j is an integer, and i≠j. The target range refers to an area covered by an entire component in an image. The target range and the similarity threshold may be set as desired.

At block S210, whether the model attention area is in a target range is determined.

In block S210, when the model attention area is in the target range, block S211 is implemented. When the model attention area is out of the target range, block S212 is implemented.

In this embodiment, when inaccurate labels classification is unselected as the abnormal reason, whether the model attention area is in the target range is determined to select lacking model input data or inaccurate model attention area as the abnormal reason.

At block S211, a number of images in the image dataset is increased.

In this embodiment, when the model attention area is in the target range, meaning lacking model input data is selected as the abnormal reason, a number of images in the image dataset is increased to increase the model input data, and blocks S202-S207 are implemented.

At block S212, auxiliary learning images are obtained.

In this embodiment, when the model attention area is out of the target range, meaning inaccurate model attention area is selected as the abnormal reason, auxiliary learning images are obtained to revise the model attention area, such that guiding the inspection model to focus on an area in the target range, and blocks S202-S207 are implemented.

In this embodiment, whether training the inspection model is finished is determined based on whether the inspection results output from the inspection model meet the preset inspection standard. When the inspection results do not meet the preset inspection standard, the abnormal reason is selected, and the image dataset or the model attention area is adjusted according to the abnormal reason to improve accuracy of model optimization, such that model training efficiency is improved.

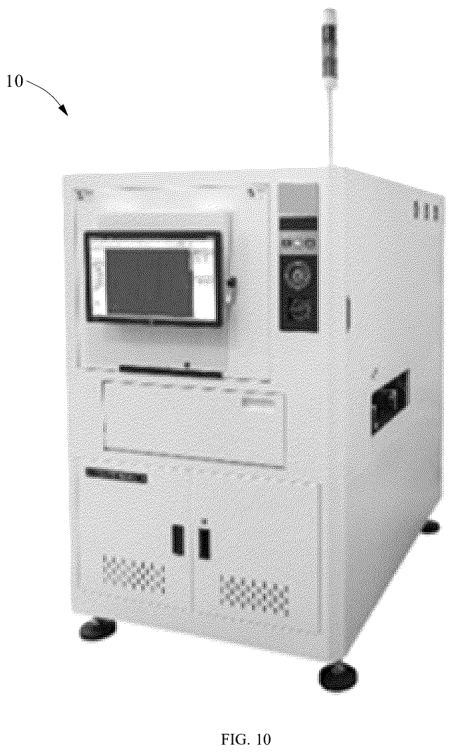

The above description illustrates a method configured for training inspection models. Each the method configured for quality inspections and the method configured for training inspection models may be applied to a device configured for quality inspections. For example, as shown in FIG. 10, the device configured for quality inspections may be a device configured for automated optical inspections (AOI), and below is a detailed description of a software structure of a device configured for quality inspections through taking a device configured for AOI as an example.

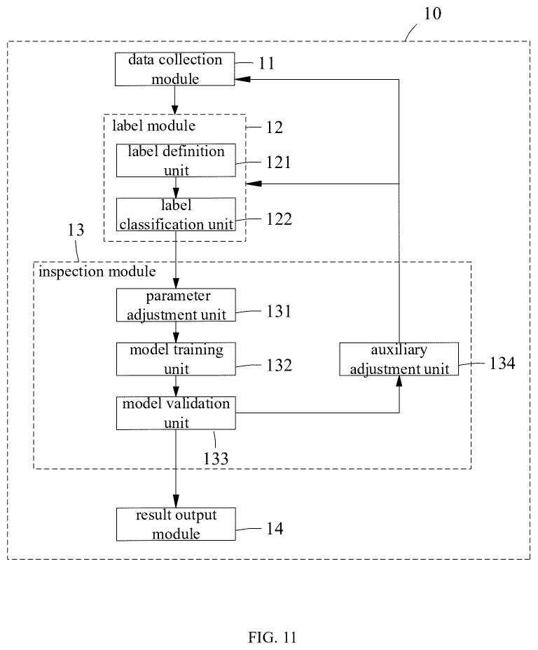

FIG. 11 is a software structure diagram of a device configured for quality inspections. As shown in FIG. 11, the device for AOI 10 comprises a data collection module 11, a label module 12, an inspection module 13, and a result output module 14.

The data collection module 11 is used to capture original images of components on a circuit board through invoking a camera; cropping the original images according to several inspection boxes to obtain several cropped images; performing size transformation on the several cropped images to obtain several images to be labeled, and the several images to be labeled are the same size.

The label module 12 comprises a label definition unit 121 and a label classification unit 122.

The label definition unit 121 is used to define the N labels according to types of inspection boxes, appearance types of components, and whether there are defects on appearances of components. N>1 and N is an integer.

The label classification unit 122 is used to labeling the several images to be labeled according to N labels to obtain N class labeled datasets corresponding to the N labels.

The inspection module 13 comprises a parameter adjustment unit 131, a model training unit 132, a model validation unit 133, and an auxiliary adjustment unit 134.

The parameter adjustment unit 131 is used to adjust parameters of an inspection model.

The model training unit 132 is used to train the inspection model based on the parameters of the inspection model and the N class labeled datasets.

The model validation unit 133 is used to validate inspection results output from the inspection model through determining whether the inspection results meet a preset inspection standard.

The auxiliary adjustment unit 134 is used to adjust the N class labeled datasets or the model attention area in case the inspection results do not meet the preset inspection standard.

The result output module 14 is used to output the inspection results in case the inspection results meet the preset inspection standard.

The above description illustrates a software structure diagram of a device configrued for quality inspections. Below is a brief description of a hardware structure diagram of a device configured for quality inspections.

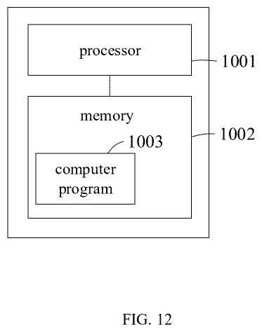

FIG. 12 is a hardware structure diagram of a device configured for quality inspections. As shown in FIG. 12, the device includes a processor 1001 and a memory 1002 coupled with the processor 1001. A computer program 1003 is stored in the memory 1002, which when executed by the processor 1001 to achieve the methods described above, which is not repeated here.

In this embodiment, the processor 1001 may be, but is not limited to, a central processing unit (CPU), a general-purpose processor, a digital signal processor (DSP), an application-specific integrated circuit (ASIC), a field-programmable gate array (FPGA) or another programmable logic device, a discrete gate or transistor logic device, a discrete hardware component. The general-purpose processor may be a microprocessor or any conventional processor.

In this embodiment, the memory 1002 may be an internal storage unit of the device, such as a hard disk or a memory of the device. In other embodiments, the memory 1002 may also be an external storage device of the device, such as a plug-in hard disk, a smart memory card (SMC), a secure digital (SD) card, a flash card. Further, the memory 1002 may also include both an internal storage unit of the device and an external storage device. The memory 1002 is used to store an operating system, a disclosure program, and other programs, such as the program code of the computer program. The memory 1002 may also be used to temporarily store data that has been output or is to be output.

In this embodiment, the computer program 1003 may include, but is not limited to, a source code form, an object code form, and an executable file.

The present disclosure further provides a computer-readable storage medium, the computer-readable storage medium is used to store a computer program. The computer program may be executed by a processor to achieve the methods described above, which is not repeated here.

The computer-readable medium may include a read-only memory (ROM), a random access memory (RAM), a USB flash drive, a mobile hard disk, a magnetic disk or an optical disk.

The above description only describes embodiments of the present disclosure, and is not intended to limit the present disclosure, various modifications and changes can be made to the present disclosure. Any modifications, equivalent substitutions, improvements, etc. made in the spirit and scope of the present disclosure are intended to be included in the scope of the present disclosure.

What is claimed is:

1. A method configured for quality inspections, the method comprising:
obtaining an image dataset of components on a circuit board to be tested, and the image dataset includes N class labeled datasets corresponding to N labels, N>1 and N is an integer;
providing and training an inspection model to output inspection results;
inputting the image dataset into the inspection model to obtain the inspection results;
when the inspection results meet a preset inspection standard, outputting the inspection results;
when the inspection results do not meet the preset inspection standard, selecting an abnormal reason according to the image dataset and a model attention area; and
adjusting the image dataset or the model attention area according to the abnormal reason until the inspection results meet the preset inspection standard.

2. The method of claim 1, wherein training the inspection model comprises:
calculating a missed inspection rate by calculating a percentage of a number of first abnormal images to a number of images in the image dataset that do not meet a preset images standard, and the first abnormal images are images in the image dataset that have defects but are classified as images meeting the preset images standard;
calculating an overkill rate by calculating a percentage of a number of second abnormal images to a number of images in the image dataset that meet the preset images standard, and the second abnormal images are images in the image dataset that meet the preset images standard but are classified as images having defects; and
including the missed inspection rate and/or the overkill rate in the inspection results.

3. The method of claim 2, the inspection results meet the preset inspection standard when:
the inspection results include the missed inspection rate, and the missed inspection rate is less than or equal to a missed inspection rate threshold; or
the inspection results include the overkill rate, and the overkill rate is less than or equal to an overkill rate threshold; or
the inspection results include the missed inspection rate and the overkill rate, wherein the missed inspection rate is less than or equal to the missed inspection rate threshold, and the overkill rate is less than or equal to the overkill rate threshold.

4. The method of claim 2, wherein training the inspection model comprises:
calculating an overkill reduction rate and a sum of the overkill reduction rate and the overkill rate is 100 %; and
including the overkill reduction rate in the inspection results.

5. The method of claim 4, the inspection results meet the preset inspection standard
when the inspection results include the overkill reduction rateand the overkill reduction rate is greater than an overkill reduction rate threshold.

6. The method of claim 1, wherein:
the abnormal reason is selected from lacking model input data, inaccurate model attention area, and inaccurate labels classification.

7. The method of claim 6, wherein when the inspection results do not meet the preset inspection standard, the method further comprising:
traversing the N class labeled datasets, and calculating a feature similarity between an i-th class labeled dataset of the N class labeled datasets and a j-th class labeled dataset of the N class labeled datasets to obtain a total of K feature similarities corresponding to the N class labeled datasets, wherein K=N×(N-1)/2, 1≤i≤N, 1≤j≤N, each i and j is an integer, and i≠j; and
when the K feature similarities are less than a similarity threshold, and the model attention area is in a target range, selecting lacking model input data as the abnormal reason.

8. The method of claim 7, wherein:
when the K feature similarities are less than a similarity threshold, and the model attention area is out of the target range, selecting inaccurate model attention area as the abnormal reason; and
when one of the K feature similarities is greater or equal to the similarity threshold, selecting inaccurate labels classification as the abnormal reason.

9. The method of claim 6, wherein when the inspection results do not meet the preset inspection standard, the method further comprising:
when lacking model input data is selected as the abnormal reason, increasing a number of images in the image dataset;
when inaccurate model attention area is selected as the abnormal reason, revising the model attention area according to auxiliary learning images; and
when inaccurate labels classification is selected as the abnormal reason, revising the N labels.

10. A method configured for training an inspection model, the method comprising:
obtaining an image dataset of components on a circuit board to be tested, and the image dataset includes N class labeled datasets corresponding to N labels, N>1 and N is an integer;
providing and training an inspection model to output inspection results;
inputting the image dataset into the inspection model to obtain the inspection results;
when the inspection results meet a preset inspection standard, saving the inspection model;
when the inspection results do not meet the preset inspection standard, selecting an abnormal reason according to the image dataset and a model attention area; and
adjusting the image dataset or the model attention area according to the abnormal reason until the inspection results meet the preset inspection standard.

11. The method of claim 10, wherein training the inspection model comprises:
calculating a missed inspection rate by calculating a percentage of a number of first abnormal images to a number of images in the image dataset that do not meet a preset images standard, and the first abnormal images are images in the image dataset that have defects but are classified as images meeting the preset images standard;
calculating an overkill rate by calculating a percentage of a number of second abnormal images to a number of images in the image dataset that meet the preset images standard, and the second abnormal images are images in the image dataset that meet the preset images standard but are classified as images having defects; and
including the missed inspection rate and/or the overkill rate in the inspection results.

12. The method of claim 11, the inspection results meet the preset inspection standard when:
the inspection results include the missed inspection rate, and the missed inspection rate is less than or equal to a missed inspection rate threshold; or
the inspection results include the overkill rate, and the overkill rate is less than or equal to an overkill rate threshold; or
the inspection results include the missed inspection rate and the overkill rate, wherein the missed inspection rate is less than or equal to the missed inspection rate threshold, and the overkill rate is less than or equal to the overkill rate threshold.

13. The method of claim 11, wherein training the inspection model comprises:
calculating an overkill reduction rate and a sum of the overkill reduction rate and the overkill rate is 100 %; and
including the overkill reduction rate in the inspection results.

14. The method of claim 13, the inspection results meet the preset inspection standard
when the inspection results include the overkill reduction rate and the overkill reduction rate is greater than an overkill reduction rate threshold.

15. The method of claim 10, wherein:
the abnormal reason is selecting from lacking model input data, inaccurate model attention area, and inaccurate labels classification.

16. The method of claim 15, wherein when the inspection results do not meet the preset inspection standard, the method further comprising:
traversing the N class labeled datasets, and calculating a feature similarity between an i-th class labeled dataset of the N class labeled datasets and a j-th class labeled dataset of the N class labeled datasets to obtain a total of K feature similarities corresponding to the N class labeled datasets, K=N×(N-1)/2, 1≤i≤N, 1≤j≤N, each i and j is an integer, and i≠j; and
when the K feature similarities are less than a similarity threshold, and the model attention area is in a target range, selecting lacking model input data as the abnormal reason.

17. The method of claim 16, wherein:
when the K feature similarities are less than a similarity threshold, and the model attention area is out of the target range, selecting inaccurate model attention area as the abnormal reason; and
when one of the K feature similarities is greater or equal to the similarity threshold, selecting inaccurate labels classification as the abnormal reason.

18. The method of claim 16, wherein when the inspection results do not meet the preset inspection standard, the method further comprising:
when lacking model input data is selected as the abnormal reason, increasing a number of images in the image dataset;
when inaccurate model attention area is selected as the abnormal reason, revising the model attention area according to auxiliary learning images; and
when inaccurate labels classification is selected as the abnormal reason, revising the N labels.

19. A device configured for quality inspections, comprising:
at least one processor;
a memory, which coupled with the at least one processor; and
a computer program stored in the memory, which when executed by the at least one processor to:
obtain an image dataset of components on a circuit board to be tested, and the image dataset includes N class labeled datasets corresponding to N labels, N>1 and N is an integer;
providing and training an inspection model to output inspection results;
input the image dataset into the inspection model to obtain the inspection results;
when the inspection results meet a preset inspection standard, output the inspection results;
when the inspection results do not meet the preset inspection standard, select an abnormal reason according to the image dataset and a model attention area; and
adjust the image dataset or the model attention area according to the abnormal reason until the inspection results meet the preset inspection standard.

20. The device of claim 19, the inspection results meet the preset inspection standard when:
the inspection results include a missed inspection rate, and the missed inspection rate is less than or equal to a missed inspection rate threshold; or
the inspection results include an overkill rate, and the overkill rate is less than or equal to an overkill rate threshold; or
the inspection results include the missed inspection rate and the overkill rate, wherein the missed inspection rate is less than or equal to the missed inspection rate threshold, and the overkill rate is less than or equal to the overkill rate threshold.
